(19) United States
(12) Patent Application Publication
(10) Pub. No.: US 2021/0222878 A1
(43) Pub. Date: Jul. 22, 2021

(54) COMBUSTOR TO VANE SEALING ASSEMBLY AND METHOD OF FORMING SAME

(71) Applicant: United Technologies Corporation, Farmington, CT (US)

(72) Inventors: Steven D. Porter, Wethersfield, CT (US); Caroline Karanian, West Hartford, CT (US); John T. Ols, Northborough, MA (US)

(21) Appl. No.: 16/746,210

(22) Filed: Jan. 17, 2020

(51) Int. Cl. F23R 3/00

(52) U.S. Cl. CPC F23R 3/00; F23R 2900/00012; F23R 2900/00018

(57) ABSTRACT

A gas turbine engine includes a turbine section including a first vane stage. The gas turbine engine further includes a combustor disposed forward of the first vane stage. The combustor includes a combustion chamber in fluid communication with the first vane stage. The combustion chamber is radially defined between a first shell and a second shell. The first shell includes a first seal assembly at an aft end of the first shell. The first seal assembly includes a conformal seal forming a first seal between the first shell and a forward face of the first vane stage. The second shell includes a second seal assembly at an aft end of the second shell. The second seal assembly includes a brush seal forming a second seal between the second shell and the forward face of the first vane stage.

### BACKGROUND

### 1. Technical Field

This disclosure relates generally to gas turbine engines, and more particularly to seal assemblies between combustors and turbine sections of gas turbine engines.

### 2. Background Information

Combustors, such as those used in gas turbine engines, may generally include radially spaced inner and outer shells which define a combustion chamber therebetween. High-energy gas flow generated in the combustion chamber may be directed into a turbine section of the gas turbine engine to effect rotation of one or more turbines. Gas turbine engines may include sealing arrangements between the combustor and the turbine section.

However, some sealing arrangements between the combustor and the turbine section may not adequately make contact with one or both of the combustor or the turbine section during operation of the gas turbine engine. As a result, some amount of leakage may occur between the combustor and cavities adjacent the combustor. Accordingly, what is needed is an improved sealing arrangement between a combustor and a turbine section of a gas turbine engine which addresses one or more of the above-discussed concerns.

### SUMMARY

It should be understood that any or all of the features or embodiments described herein can be used or combined in any combination with each and every other feature or embodiment described herein unless expressly noted otherwise.

According to an embodiment of the present disclosure, a gas turbine engine includes a turbine section including a first vane stage. The gas turbine engine further includes a combustor disposed forward of the first vane stage. The combustor includes a combustion chamber in fluid communication with the first vane stage. The combustion chamber is radially defined between a first shell and a second shell. The first shell includes a first seal assembly at an aft end of the first shell. The first seal assembly includes a conformal seal forming a first seal between the first shell and a forward face of the first vane stage. The second shell includes a second seal assembly at an aft end of the second shell. The second seal assembly includes a brush seal forming a second seal between the second shell and the forward face of the first vane stage.

In the alternative or additionally thereto, in the foregoing embodiment, the brush seal includes a brush seal backing plate, retaining ring, and a plurality of bristles retained between the brush seal backing plate and the retaining ring.

In the alternative or additionally thereto, in the foregoing embodiment, the plurality of bristles extend axially between the second shell and the forward face of the first vane stage.

In the alternative or additionally thereto, in the foregoing embodiment, the second seal is a secondary seal and the second seal assembly further includes a hard seal. The hard seal forms a primary seal between the second shell and the forward face of the first vane stage.

In the alternative or additionally thereto, in the foregoing embodiment, the hard seal includes a radially extending face of the second shell in contact with the forward face of the first vane stage.

In the alternative or additionally thereto, in the foregoing embodiment, the hard seal is disposed radially between the brush seal and the combustion chamber.

In the alternative or additionally thereto, in the foregoing embodiment, the conformal seal includes a wearing end portion extending axially aft from the conformal seal and configured to wear down during initial operation of the gas turbine engine to form the first seal with the forward face of the first vane stage.

In the alternative or additionally thereto, in the foregoing embodiment, the gas turbine engine includes at least one aft liner panel mounted to the second shell radially adjacent the second seal assembly.

In the alternative or additionally thereto, in the foregoing embodiment, the combustor includes a single mounting point between the combustor and a fixed casing structure of the gas turbine engine. The single mounting point is disposed between the second shell and the fixed casing structure.

According to another embodiment of the present disclosure, a method for providing a seal between a combustor and a turbine section of a gas turbine engine includes providing the combustor including a combustion chamber radially defined between a first shell and a second shell. The method further includes forming a first seal between an aft end of the first shell and a forward face of a first vane stage of the turbine section with a first seal assembly including a conformal seal. The method further includes forming a second seal between an aft end of the second shell and the forward face of the first vane stage of the turbine section with a second seal assembly including a brush seal.

In the alternative or additionally thereto, in the foregoing embodiment, the brush seal includes a brush seal backing plate, retaining ring, and a plurality of bristles retained between the brush seal backing plate and the retaining ring.

In the alternative or additionally thereto, in the foregoing embodiment, the plurality of bristles extends axially between the second shell and the forward face of the first vane stage.

In the alternative or additionally thereto, in the foregoing embodiment, the second seal is a secondary seal and the second seal assembly further includes a hard seal. The method further includes forming a primary seal between the second shell and the forward face of the first vane stage with the hard seal.

In the alternative or additionally thereto, in the foregoing embodiment, the hard seal includes a radially extending face of the second shell in contact with the forward face of the first vane stage.

In the alternative or additionally thereto, in the foregoing embodiment, the hard seal is disposed radially between the brush seal and the combustion chamber.

In the alternative or additionally thereto, in the foregoing embodiment, the conformal seal includes a wearing end portion extending axially aft from the conformal seal. The method further includes wearing down the wearing end portion during initial operation of the gas turbine engine to form the first seal with the forward face of the first vane stage.

In the alternative or additionally thereto, in the foregoing embodiment, the combustor further includes at least one aft liner panel mounted to the second shell radially adjacent the second seal assembly.

According to another embodiment of the present disclosure, a gas turbine engine includes a turbine section including a first vane stage. The gas turbine engine further includes a combustor disposed forward of the first vane stage. The combustor includes a combustion chamber in fluid communication with the first vane stage. The combustion chamber is defined between an inner shell and an outer shell. The inner shell includes an inner diameter seal assembly at an aft end of the inner shell. The inner diameter seal assembly includes a hard seal forming a first inner diameter seal between the inner shell and the forward face of the first vane stage, and a brush seal, disposed radially inward of the hard seal, forming a second inner diameter seal between the inner shell and the forward face of the first vane stage.

In the alternative or additionally thereto, in the foregoing embodiment, the outer shell includes an outer diameter seal assembly at an aft end of the outer shell. The outer diameter seal assembly includes a conformal seal forming an outer diameter seal between the outer shell and the forward face of the first vane stage.

In the alternative or additionally thereto, in the foregoing embodiment, the brush seal includes a brush seal backing plate, retaining ring, and a plurality of bristles retained between the brush seal backing plate and the retaining ring and the plurality of bristles extends axially between the inner shell and the forward face of the first vane stage.

The present disclosure, and all its aspects, embodiments and advantages associated therewith will become more readily apparent in view of the detailed description provided below, including the accompanying drawings.

### BRIEF DESCRIPTION OF THE DRAWINGS

FIG. 1 illustrates a side cross-sectional view of a gas turbine engine in accordance with one or more embodiments of the present disclosure.

FIG. 2 illustrates a cross-sectional view of an exemplary combustor of a gas turbine engine in accordance with one or more embodiments of the present disclosure.

FIG. 3 illustrates a perspective cutaway view of an outer diameter seal assembly of the combustor of FIG. 2 in accordance with one or more embodiments of the present disclosure.

FIG. 4 illustrates a cross-sectional side view of an inner diameter seal assembly of the combustor of FIG. 2 in accordance with one or more embodiments of the present disclosure.

### DETAILED DESCRIPTION

It is noted that various connections are set forth between elements in the following description and in the drawings. It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities. It is further noted that various method or process steps for embodiments of the present disclosure are described in the following description and drawings. The description may present the method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

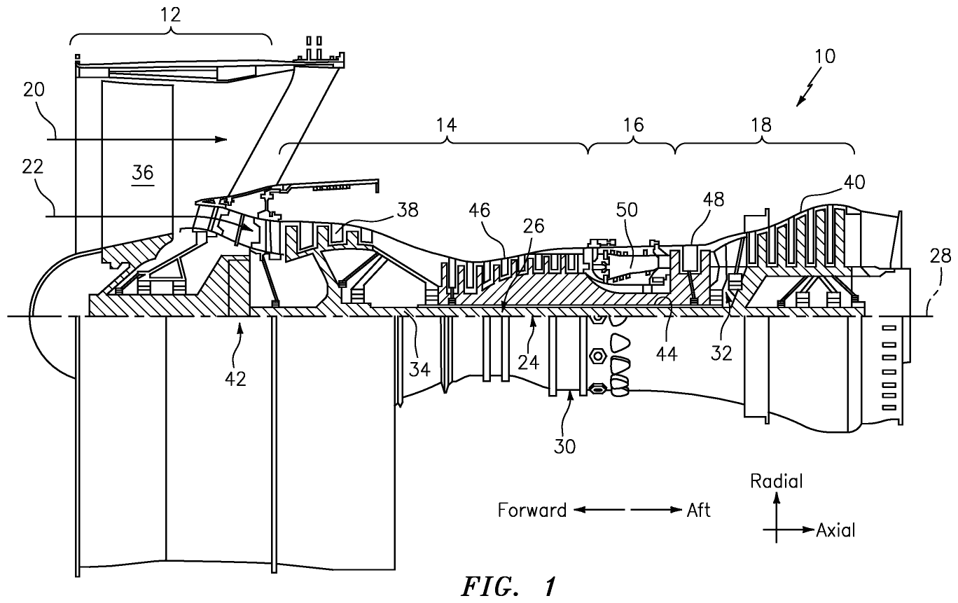

Referring to FIG. 1, an exemplary gas turbine engine 10 is schematically illustrated. The gas turbine engine 10 is disclosed herein as a two-spool turbofan engine that generally includes a fan section 12, a compressor section 14, a combustor section 16, and a turbine section 18. The fan section 12 drives air along a bypass flowpath 20 while the compressor section 14 drives air along a core flowpath 22 for compression and communication into the combustor section 16 and then expansion through the turbine section 18. Although depicted as a turbofan gas turbine engine in the disclosed non-limiting embodiments, it should be understood that the concepts described herein are not limited to use with turbofans as the teachings may be applied to other types of turbine engines including those with three-spool architectures.

The gas turbine engine 10 generally includes a low-pressure spool 24 and a high-pressure spool 26 mounted for rotation about a longitudinal centerline 28 of the gas turbine engine 10 relative to an engine static structure 30 via one or more bearing systems 32. It should be understood that various bearing systems 32 at various locations may alternatively or additionally be provided.

The low-pressure spool 24 generally includes a first shaft 34 that interconnects a fan 36, a low-pressure compressor 38, and a low-pressure turbine 40. The first shaft 34 is connected to the fan 36 through a gear assembly of a fan drive gear system 42 to drive the fan 36 at a lower speed than the low-pressure spool 24. The high-pressure spool 26 generally includes a second shaft 44 that interconnects a high-pressure compressor 46 and a high-pressure turbine 48. It is to be understood that “low pressure” and “high pressure” or variations thereof as used herein are relative terms indicating that the high pressure is greater than the low pressure. An annular combustor 50 is disposed between the high-pressure compressor 46 and the high-pressure turbine 48 along the longitudinal centerline 28. The first shaft 34 and the second shaft 44 are concentric and rotate via the one or more bearing systems 32 about the longitudinal centerline 28 which is collinear with respective longitudinal centerlines of the first and second shafts 34, 44.

Airflow along the core flowpath 22 is compressed by the low-pressure compressor 38, then the high-pressure compressor 46, mixed and burned with fuel in the combustor 50, and then expanded over the high-pressure turbine 48 and the low-pressure turbine 40. The low-pressure turbine 40 and the high-pressure turbine 48 rotationally drive the low-pressure spool 24 and the high-pressure spool 26, respectively, in response to the expansion.

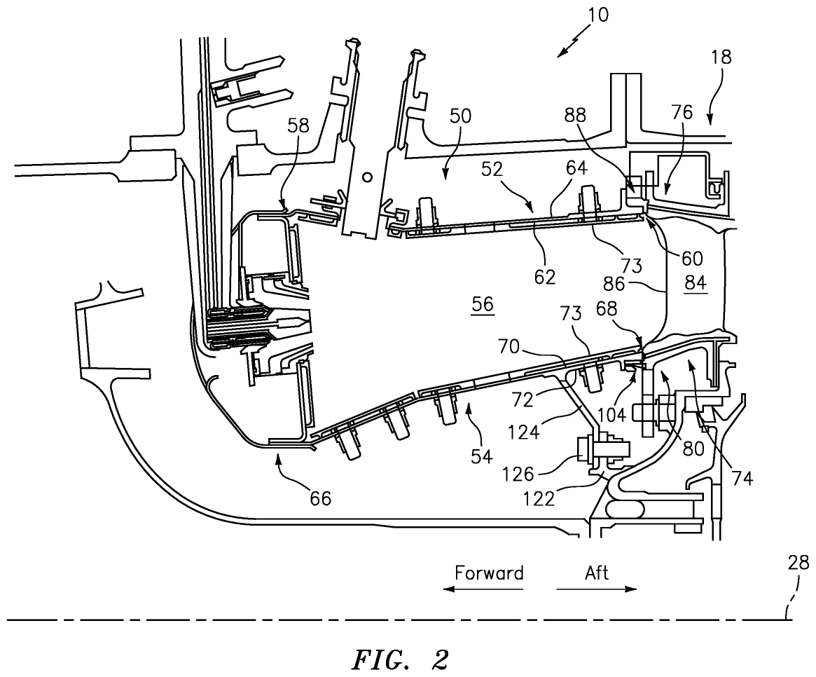

Referring to FIG. 2, the combustor 50 includes an annular outer shell 52 and an annular inner shell 54 spaced radially inward of the outer shell 52, thus defining an annular combustion chamber 56 therebetween. The outer shell 52 includes an axially forward end 58 and an axially aft end 60 as well as a first surface 62 facing the combustion chamber 56 and a second surface 64 opposite the first surface 62. Similarly, the inner shell 54 includes an axially forward end 66 and an axially aft end 68 as well as a first surface 70 facing the combustion chamber 56 and a second surface 72 opposite the first surface 70. The combustor 50 may further include a plurality of liner panels 73 mounted to the respective first surfaces 62, 70 of one or both of the outer shell 52 and the inner shell 54. It should be understood that relative positional terms, such as “forward,” “aft,” “upper,” “lower,” “above,” “below,” and the like are relative to the normal operational attitude of the gas turbine engine 10 and should not be considered otherwise limiting.

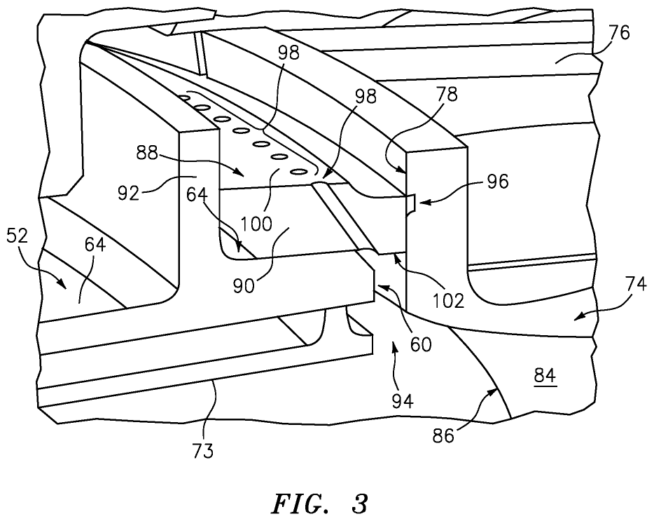

Referring to FIGS. 2-4, the turbine section 18 of the gas turbine engine 10 includes a first vane stage 74 which may be a forward-most vane stage of the turbine section 18. As shown in FIG. 2, the combustor 50 is axially forward of the first vane stage 74 and the combustion chamber 56 is in fluid communication with the first vane stage 74. The first vane stage 74 includes an upper platform 76 which defines an outer diameter forward face 78 of the first vane stage 74 which is adjacent the axially aft end 60 of the outer shell 52. The first vane stage 74 further includes a lower platform 80 which defines an inner diameter forward face 82 of the first vane stage 74 which is adjacent the axially aft end 68 of the inner shell 54.

The first vane stage 74 includes a plurality of vanes 84 that extend between the upper platform 76 and the lower platform 80. Each vane of the plurality of vanes 84 includes a leading edge 86 facing toward the combustion chamber 56. The leading edge 86 encounters the high-energy gas flow generated in the combustion chamber 56 and directs that gas flow further downstream in the turbine section 18.

The outer shell 52 is in sealed communication with the first vane stage 74 via an outer diameter seal assembly 88 disposed at the axially aft end 60 of the outer shell 52. The outer diameter seal assembly 88 includes a conformal seal 90 forming an outer diameter seal between the outer shell 52 and the outer diameter forward face 78 of the first vane stage 74. The outer shell 52 may include a rib 92 which extends radially outward from the second surface 64 of the outer shell 52 and which is axially spaced from the axially aft end 60 of the outer shell 52. The conformal seal 90 may be disposed between the rib 92 and the outer diameter forward face 78 of the first vane stage 74 on the second surface 64 of the outer shell 52. The conformal seal 90 may extend axially aft from the rib 92 over a radially extending gap 94 between the outer shell 52 and the first vane stage 74.

The conformal seal 90 may include a wearing end portion 96 extending axially aft from the conformal seal 90 and configured to wear down during initial operation of the gas turbine engine 10 to form the outer diameter seal with the outer diameter forward face 78 of the first vane stage 74. In various embodiments, the conformal seal 90 may include a plurality of cooling holes 98 which extend between a radially outer surface 100 and a radially inner surface 102 of the conformal seal 90. The plurality of cooling holes 98 may be in fluid communication with the radially extending gap 94 so as to provide cooling air to the radially extending gap 94.

The inner shell 54 is in sealed communication with the first vane stage 74 via an inner diameter seal assembly 104 disposed at the axially aft end 68 of the inner shell 54. In various embodiments, the inner diameter seal assembly 104 may include a hard seal 106 forming an inner diameter seal between the inner shell 54 and the inner diameter forward face 82 of the first vane stage 74. The hard seal 106 may be defined by a radially extending surface 108 of the inner shell 54 at the axially aft end 68 which is in contact with the inner diameter forward face 82 of the first vane stage 74.

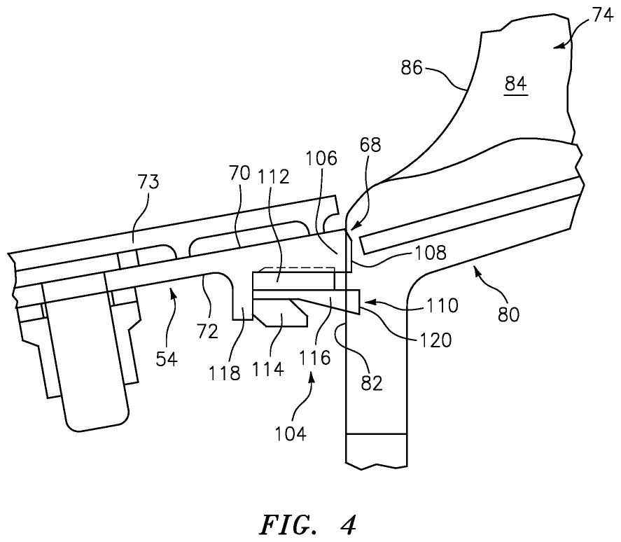

The inner diameter seal assembly 104 includes a brush seal 110 forming an inner diameter seal between the inner shell 54 and the inner diameter forward face 82 of the first vane stage 74. In various embodiments, the inner diameter seal assembly 104 may include both the hard seal 106 forming a first inner diameter seal and the brush seal 110 forming a second inner diameter seal. Alternatively, in various other embodiments, the inner diameter seal assembly 104 may include the brush seal 110 and may not include the hard seal 106. As shown in FIGS. 2 and 4, the brush seal 110 may be disposed radially inward of the hard seal 106, however, the brush seal 110 is not limited to such a location and may be, for example, disposed radially outward of the hard seal 106.

The brush seal 110 may include a brush seal backing plate 112, a retaining ring 114, and a plurality of bristles 116 radially retained between the brush seal backing plate 112 and the retaining ring 114. The inner shell 54 may include a rib 118 which extends radially inward from the second surface 72 of the inner shell 54 and which is axially spaced from the axially aft end 68 of the inner shell 54. The brush seal 110 may be disposed between the rib 118 and the inner diameter forward face 82 of the first vane stage 74 on the second surface 72 of the inner shell 54. The plurality of bristles 116 may extend axially between the inner shell 54 and the inner diameter forward face 82 of the first vane stage 74 so as to contact the inner diameter forward face 82 with a distal end 120 of the plurality of bristles 116. The brush seal 110 may have improved contact with the inner diameter forward face 82 of the first vane stage 74, as compared to the hard seal 106 and, therefore, may provide greater sealing between the inner shell 54 and the first vane stage 74 relative to an inner diameter seal assembly including a hard seal alone.

While the outer diameter seal assembly 88 is discussed above as including the conformal seal 90 and the inner diameter seal assembly 104 is discussed above as including one or both of the hard seal 106 and the brush seal 110, it should be understood that other configurations of the seals 90, 106, 110 may be used. For example, in various embodiments, the outer diameter seal assembly 88 may include one or both of the hard seal 106 and the brush seal 110 while the inner diameter seal assembly 104 may include the conformal seal 90.

In various embodiments, at least one liner panel of the plurality of liner panels 73, for example, an aft liner panel, may be mounted to the outer shell 52 radially inward (e.g., radially adjacent) of the outer diameter seal assembly 88. In various embodiments, at least one liner panel of the plurality of liner panels 73, for example, an aft liner panel, may be mounted to the inner shell 54 radially outward (e.g., radially adjacent) of the inner diameter seal assembly 104.

In various embodiments, the combustor 50 may include a single mounting point between the combustor 50 and a fixed casing structure 122 of the gas turbine engine 10. For example, the inner shell 54 may include an inner diameter leg 124 extending from the second surface 72 of the inner shell 54 and mounted to the fixed casing structure 122 via one or more fasteners 126. As a result of the single mounting point between the combustor 50 and the fixed casing structure 122, the combustor 50 may experience some rocking and twisting relative to the first vane stage 74 during operation of the gas turbine engine 10. Inclusion of the brush seal 110 in the inner diameter seal assembly 104 may accommodate the rocking and twisting while still provided adequate sealing between the inner shell 54 and the first vane stage 74.

While various aspects of the present disclosure have been disclosed, it will be apparent to those of ordinary skill in the art that many more embodiments and implementations are possible within the scope of the present disclosure. For example, the present disclosure as described herein includes several aspects and embodiments that include particular features. Although these particular features may be described individually, it is within the scope of the present disclosure that some or all of these features may be combined with any one of the aspects and remain within the scope of the present disclosure. References to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Accordingly, the present disclosure is not to be restricted except in light of the attached claims and their equivalents.

What is claimed is:

1. A gas turbine engine comprising:
a turbine section comprising a first vane stage; and
a combustor disposed forward of the first vane stage, the combustor comprising a combustion chamber in fluid communication with the first vane stage, the combustion chamber radially defined between a first shell and a second shell, the first shell comprising a first seal assembly at an aft end of the first shell, the first seal assembly comprising a conformal seal forming a first seal between the first shell and a forward face of the first vane stage, the second shell comprising a second seal assembly at an aft end of the second shell, the second seal assembly comprising a brush seal forming a second seal between the second shell and the forward face of the first vane stage.

2. The gas turbine engine of claim 1, wherein the brush seal comprises a brush seal backing plate, retaining ring, and a plurality of bristles retained between the brush seal backing plate and the retaining ring.

3. The gas turbine engine of claim 2, wherein the plurality of bristles extends axially between the second shell and the forward face of the first vane stage.

4. The gas turbine engine of claim 3, wherein the second seal is a secondary seal and wherein the second seal assembly further comprises a hard seal, the hard seal forming a primary seal between the second shell and the forward face of the first vane stage.

5. The gas turbine engine of claim 4, wherein the hard seal comprises a radially extending face of the second shell in contact with the forward face of the first vane stage.

6. The gas turbine engine of claim 4, wherein the hard seal is disposed radially between the brush seal and the combustion chamber.

7. The gas turbine engine of claim 1, wherein the conformal seal comprises a wearing end portion extending axially aft from the conformal seal and configured to wear down during initial operation of the gas turbine engine to form the first seal with the forward face of the first vane stage.

8. The gas turbine engine of claim 6, further comprising at least one aft liner panel mounted to the second shell radially adjacent the second seal assembly.

9. The gas turbine engine of claim 1, wherein the combustor comprises a single mounting point between the combustor and a fixed casing structure of the gas turbine engine, the single mounting point disposed between the second shell and the fixed casing structure.

10. A method for providing a seal between a combustor and a turbine section of a gas turbine engine, the method comprising:
providing the combustor comprising a combustion chamber radially defined between a first shell and a second shell;
forming a first seal between an aft end of the first shell and a forward face of a first vane stage of the turbine section with a first seal assembly comprising a conformal seal; and
forming a second seal between an aft end of the second shell and the forward face of the first vane stage of the turbine section with a second seal assembly comprising a brush seal.

11. The method of claim 10, wherein the brush seal comprises a brush seal backing plate, retaining ring, and a plurality of bristles retained between the brush seal backing plate and the retaining ring.

12. The method of claim 11, wherein the plurality of bristles extends axially between the second shell and the forward face of the first vane stage.

13. The method of claim 12, wherein the second seal is a secondary seal and wherein the second seal assembly further comprises a hard seal, the method further comprising forming a primary seal between the second shell and the forward face of the first vane stage with the hard seal.

14. The method of claim 13, wherein the hard seal comprises a radially extending face of the second shell in contact with the forward face of the first vane stage.

15. The method of claim 14, wherein the hard seal is disposed radially between the brush seal and the combustion chamber.

16. The method of claim 10, wherein the conformal seal comprises a wearing end portion extending axially aft from the conformal seal, the method further comprising wearing down the wearing end portion during initial operation of the gas turbine engine to form the first seal with the forward face of the first vane stage.

17. The method of claim 10, wherein the combustor further comprises at least one aft liner panel mounted to the second shell radially adjacent the second seal assembly.

18. A gas turbine engine comprising:
a turbine section comprising a first vane stage; and
a combustor disposed forward of the first vane stage, the combustor comprising a combustion chamber in fluid communication with the first vane stage, the combustion chamber defined between an inner shell and an outer shell, the inner shell comprising an inner diameter seal assembly at an aft end of the inner shell, the inner diameter seal assembly comprising a hard seal forming a first inner diameter seal between the inner shell and the forward face of the first vane stage, and a brush seal, disposed radially inward of the hard seal, forming a second inner diameter seal between the inner shell and the forward face of the first vane stage.

19. The gas turbine engine of claim 18, wherein the outer shell comprises an outer diameter seal assembly at an aft end of the outer shell, the outer diameter seal assembly comprising a conformal seal forming an outer diameter seal between the outer shell and the forward face of the first vane stage.

20. The gas turbine engine of claim 18, wherein the brush seal comprises a brush seal backing plate, retaining ring, and a plurality of bristles retained between the brush seal backing plate and the retaining ring and wherein the plurality of bristles extends axially between the inner shell and the forward face of the first vane stage.
